(19) United States
(12) Patent Application Publication
(10) Pub. No.: US 2008/0257382 A1
(43) Pub. Date: Oct. 23, 2008

(54) Cleaning Solution and Wipes and Method for Cleaning

(75) Inventor: Peter Lawrence Steven, Victora (AU)

Correspondence Address: Husch Blackwell Sanders, LLP;Welsh & Katz, 120 S RIVERSIDE PLAZA, 22ND FLOOR, CHICAGO, IL, 60606, US

(73) Assignee: SUNNYWIES PTY LTD., Neilborough, Victoria (AU)

(21) Appl. No.: 10/592,196

(22) PCT Filed: Mar. 9, 2005
(86) PCT No.: PCT/AU2005/000330

§ 371 Date: Jun. 30, 2008

(30) Foreign Application Priority Data
Mar. 9, 2004 (AU) 2004901225

(51) Int. Cl. B08B 7/00; C11D 3/16

(52) U.S. Cl. 134/6; 510/163

(57) ABSTRACT

The present invention provides a cleaning solution, a wipe impregnated with the cleaning solution and packages/dispenser including such wipes which can be used to effectively clean a variety of articles such as optical lenses, optical glasses, camera and video camera lenses, head and face protective masks, scientific instruments including gauges, windows, mirrors household fixtures, bathroom fittings, motor vehicles, boats and their components and the like, as well as the hands of the cleaner. In particular, the cleaning solution comprises cineole in an amount of between about 20% and about 60% by weight of the solution and up to about 80% by weight of the solution of a suitable solvent. The invention is also directed to methods of producing a cleaning solution, of producing a wipe impregnated with the cleaning solution and packages/dispensers including such wipes as well as methods of cleaning surfaces and, in particular, of cleaning hands.

### FIELD OF THE INVENTION

The present invention provides a cleaning solution, a wipe impregnated with the cleaning solution and packages/dispensers including such wipes which can be used to effectively clean a variety of articles such as optical lenses, optical glasses, camera and video camera lenses, head and face protective masks including helmets, goggles and visors, scientific instruments including gauges, windows, mirrors, household fixtures, bathroom fittings, bench tops, motor vehicles, boats and their components and the like, as well as the hands of the cleaner. The invention is also directed to methods of producing a cleaning solution, of producing a wipe impregnated with the cleaning solution and packages/dispensers including such wipes as well as methods of cleaning surfaces and, in particular, of cleaning hands.

### BACKGROUND OF THE INVENTION

Although there are many products that are available for the cleaning of windows, mirrors and lenses ranging from optical glasses, sunglasses to lenses used in cameras and video cameras, many of these products either do not effectively clean the surface or they leave a visible residue on the surface. These cleaning solutions available for professional photographers and the like are often not easily portable. Additionally, these products usually come in the form of a handheld liquid spray. This requires the user to spray the product onto the surface and employ a cloth or the like to wipe away the dirt, grime, oil and/or facial products. A further disadvantage of spray cleaners is that the cloth or the like required to wipe the liquid spray and any grease or grime from the surface is often unclean itself. This often results in an ineffective cleaning product that leaves a visible residue.

Furthermore, the general public usually resort to using clothing or even tissues to try to clean these types of lenses. They are not generally effective at removing dirt, oils, fingerprints, hair products such as hairspray, mousse or even facial creams including sunscreens. Additionally, they have the disadvantage that they may give rise to scratching of the surface, which is clearly not desirable, especially in the case of valuable optical lenses.

Users of optical glasses, sunglasses, cameras or the like may also often encounter difficulties with insects landing and crawling on the lens. It would be preferable to have a solution that repels insects from landing on lens surfaces.

A package containing a cleaning wipe comprising a solution consisting of at least one solvent which may be methylated spirits and at least one oil which may be one of lemon, eucalyptus, rose or lavender oil, impregnating an absorbent material has previously been disclosed in AU 731352. The cleaning wipe is disclosed as being useful for cleaning optical glasses, sunglasses, cameras or the like. The cleaning wipe of the present invention is also useful for cleaning any surface in order to remove dirt, dust, grime and the like. The cleaning wipe can be used in applications as varied as a mechanic using the wipe to clean a vehicle window and its trim to a kitchen hand using it to wipe down benches making use of both the ability to remove dirt and the like as well as the anti-microbial action of the cleaning solution. The surface that the cleaning wipe is able to clean may also include the hands of the cleaner.

The present inventor has now determined that by controlling the constituents of cleaning solutions to require the presence of 20% to 60% cineole and suitable solvent, it is possible to ensure that the residue left on the surface after the cleaning operation is substantially invisible to the naked eye, while enabling effective cleaning of the surface concerned. Other advantages that will become apparent from the following description of the invention may also be associated with the cleaning solutions and impregnated wipes according to the invention.

### SUMMARY OF THE INVENTION

The present invention relates to a cleaning solution comprising cineole in the amount of between about 20% and about 60% by weight of the solution and up to about 80% by weight of the solution of a suitable solvent.

In one aspect of the invention a substantially lint free absorbent material is impregnated with the above cleaning solution producing a presaturated wipe which can be used to apply the solution to a surface.

In another aspect of the invention an optical cleaning product comprises a sealed package enclosing one or more presaturated wipes.

In a preferred embodiment, the above cleaning solution comprises a solvent which can be selected from one or more of methylated spirits, C₁ to C₁₀ alcohols, preferably selected from one or more of methanol, ethanol, isopropanol and methylated spirits. In a still preferred further embodiment, the solvent is ethanol and of analytical grade (A.R). In a preferred embodiment the above cleaning solution comprises one or more essential oils and/or fractions thereof comprising cineole compounds, preferably 1,8-cineole, which are preferably selected from the group eucalyptus, tea tree, bayleaf, spearmint and rosemary. In a still further preferred embodiment, eucalyptus oil of B.P. grade (where it complies with British Pharmacopoeia requirements) is used. Preferably, the amount by weight of cineole in the eucalyptus oil is at least 60%, and preferably between 75% and 85%. In a preferred embodiment, the amount by weight of eucalyptus oil in the cleaning solution is between about 40% and about 60% and ethanol constitutes the remainder of the solution. In a more preferred embodiment, the amount by weight of eucalyptus oil in the cleaning solution is 50% and ethanol constitutes the remainder of the solution.

In a preferred embodiment the solution is adapted to be sprayed onto a surface. The solution may be wiped with a lint free cloth or the like. In a still further preferred embodiment, following application to a surface, and after evaporation from the surface of volatile components of the solution, a residue remains that is substantially invisible to the naked eye. Preferably the residue results in a substantially electrically neutralising barrier between the surface and the air. Preferably the residue results in the reduction of the perception of mist by either increasing the ability of the water to spread uniformly on a surface or by increasing the ability of the droplets to run off the surface.

In a preferred embodiment the refractive index of the residue is substantially similar to glass and preferably between about 1.4 and about 1.55. In a preferred embodiment, the residue gives rise to a contact angle of water between 0 and 30 degrees. In a preferred embodiment the solution has anti-microbial activity and preferably acts as an insect repellant. In a more preferred embodiment, the solution is physiologically compatible with skin.

In a preferred embodiment, volatile components of the solution impregnated in the presaturated wipe evaporate on exposure to air, resulting in a substantially dry wipe after use. Preferably the substantially dry material can be used to buff the surface. Preferably, the solution is compatible with the surface wherein the surface can be selected from glass, perspex, plastic or the like. In a still preferred embodiment, the presaturated wipe can be enclosed in a sealed, substantially air impervious package.

Another aspect of the present invention relates to a method of preparing a presaturated wipe for applying a solution to a surface which comprises impregnating a substantially lint free absorbent material with an appropriate amount of the above cleaning solution.

Another aspect of the present invention involves a method of producing a cleaning product which comprises packaging the above described presaturated wipe in a substantially air impervious package.

Another aspect of the present invention involves a method of cleaning a surface of an optical lens which comprises wiping a surface with a presaturated wipe which comprises a substantially lint free absorbent material that has been impregnated with an appropriate amount of cleaning solution as described above. Preferably the solution solubilises dirt, dust, grime or the like.

In a further aspect, the present invention involves a method of producing an optical cleaning product which comprises enclosing one or more of the above described presaturated wipes in a sealed package. In a preferred embodiment the package is substantially air impervious.

### DETAILED DESCRIPTION OF THE PREFERRED EMBODIMENTS

In a preferred embodiment, the above cleaning solution comprises a solvent which can be selected from one or more of methylated spirits, C₁ to C₁₀ alcohols, preferably selected from one or more of methanol, ethanol, isopropanol and methylated spirits. It is desirable for the solvent to be non-toxic since with normal use it would come into contact with skin. The solvent is required to be compatible with the oil, in that that oil is soluble in the solvent. The solution should also be compatible with the surface that it is required to clean. By this it is intended to mean that the solution should not degrade, buckle or otherwise deform the surface to any significant extent. The surface is preferably glass, perspex, plastic or a composite material having the desirable optical characteristics, in the case of optical lenses. The solution may also be appropriately used to clean surfaces, for example of porcelain or ceramic, metal, vinyl or other plastics, leather, timber and painted or enameled surfaces.

In a still preferred further embodiment, the solvent is ethanol and of analytical grade (A.R). In a preferred embodiment the above cleaning solution comprises one or more essential oils and/or fractions thereof comprising cineole which are generally obtained from distillation of fresh, dried or partially dried plants or plant derived materials. The essential oil may be obtained from components such as leaves, branches, shoots, stems, bark, seeds, fruit, roots, nuts or the like derived from one or more plants. The essential oil fractions may be obtained from distillation, purification, refining or the like of essential oils or components thereof. The essential oils and/or fractions are preferably selected from the group eucalyptus, tea tree, bayleaf, spearmint and rosemary, although other plant species may also give rise to the essential oils containing 20% to 100% of cineole compounds, preferably 1,8-cineole. In a still further preferred embodiment, eucalyptus oil of B.P. grade (where it complies with British Pharmacopoeia requirements) is used. The amount by weight of cineole in the essential oil, preferably eucalyptus oil, is at least 60%, preferably between 75% and 85%. In a preferred embodiment, the amount by weight of the essential oil, preferably eucalyptus oil, within the solution is between about 40% and about 60% and ethanol makes up the remainder of the solution. In a more preferred embodiment, the amount by weight of eucalyptus oil in the cleaning solution is 50% and ethanol constitutes the remainder of the solution.

In a preferred embodiment the solution is adapted to be sprayed onto a surface. This can be achieved by methods such as atomising the solution in an atomiser, spray pump, vaporiser or aerosol, as are well understood in the art. The cleaning solution may be stored in bottles or pump spray packs.

In a still further preferred embodiment, following application to a surface, and after evaporation of volatile components of the solution, a residue is left which is substantially invisible to the naked eye. The solution may be wiped with a lint free cloth or the like. It has been observed that advantageously surfaces to which the solution has been applied have reduced the ability of contaminants to adhere to the surfaces and reduced the appearance of fog or mist. Without wishing to be bound by theory, the above features may have been achieved by the residue resulting in a substantially electrically neutralising barrier between the surface and the air. This insulating property is thought to result from the electrically neutralising character of 1,8-cineole. It is thought that an electrically neutralising layer serves to prevent or at least minimize the electrostatic adhesion of contaminants onto the surface. Trials have shown that this residue is very effective in preventing a build up of contaminants on optical safety wear such as welding goggles, safety goggles and fire safety masks, for example. It has also been found that after application of the cleaning solution, surfaces (such as glass surfaces) may remain clean from electrostatic build up of contaminants for numerous days when left out in the open. Prevention or slowing of build up of dust and/or smoke particles on fire safety goggles is of particular importance, especially when considered in conjunction with the ability to prevent or at least slow build up of fog on interior surfaces of such equipment, as these characteristics could lead to the saving of lives in fire emergencies.

In a preferred embodiment, the residue significantly minimizes or at least slows the process of water droplet formation. Without wishing to be bound by theory it is believed that the residue results in a reduction of the contact angle between water and the surface. A consequence of the reduced contact angle is a greater spreading of the water, which reduces the perception of fog or mist by creating a film. This is a particular advantage in rainy or humid conditions, as the surface will not retain water as distinct droplets to thus interfere with optical properties of the surface. When the surface is standard glass, the contact angle on a clean glass surface is usually measured in the range of between about 25 and about 40 degrees while after application of the solution the contact angle between the surface and water is usually measured in the range of between about 10 and about 25 degrees.

In another embodiment, the residue may result in increasing the ability of any water droplets formed to roll off the surface again having the effect of reducing the perception of fog or mist.

The usefulness of the cleaning solution as described above would be diminished if a residue or film could be detected by the naked eye following treatment of a surface. The preferred composition of the solution as described above results in the film residue being substantially invisible to the naked eye. In a preferred embodiment the refractive index of the residue is substantially similar to glass and preferably between about 1.4 and about 1.55. Since the residue is optically substantially similar to the glass, the residue is substantially unobservable to the naked eye, in the case for example where the surface is part of an optical lens.

In a preferred embodiment the solution has anti-microbial activity and hence the residue will kill, slow growth and/or cellular division and/or repel microorganisms such as bacteria, viruses, pathogens, fungi and the like. In a still preferred embodiment, the solution repels insects or the like from the surface. This is an advantage especially when wearing optical glasses that insects such as flies and mosquitoes will not be attracted to around the facial area or in the case where the surface is part of a bathroom fitting (eg. basin or toilet) or is in a food preparation area. The solution may be used on the frame of eye glasses in addition to the lens, which results in additional protection. Additionally, the solution could be used to clean the users hands, as a general anti-microbial cleaner.

In a preferred embodiment the presaturated wipe comprises an absorbent, substantially lint free sheet material that has preferably the dimensions of between about 4 cm to about 50 cm wide and 4 cm to 50 cm in length. Preferably the wipe does not scratch the lens. The absorbent material is to be compatible with the solution and may for example be produced from paper or polymeric material. By “compatible” in this context it is intended to mean that the absorbent material should not unduly weaken, degrade or disintegrate on impregnation. Also in a preferred embodiment the solution evaporates on exposure to air, resulting in a substantially dry wipe after a reasonable period of time. Preferably, the wipe is sufficiently moist to effectively clean the required surface but the majority of the solution is able to evaporate in a reasonable time, such as between about 10 seconds and 2 minutes, preferably approximately 20 seconds to 1 minute, which will vary depending upon the volatility of the solution and the level of impregnation. This wipe can be used to buff the surface after a reasonable period of time.

A preferred embodiment is an optical cleaning product which comprises enclosing one or more presaturated wipes as described above, in a sealed package wherein the package is substantially air impervious. Sealed packages of this type are well known in the art and include packages produced from polymeric material, foils and polymer coated foils, for example. Substantially air impervious packages can encompass dispensing canisters which can hold a multiple presaturated wipes. Any container that is substantially impervious to the air could be used to hold a multitude of presaturated wipes. The solution could also be contained such that it can be easily dispensed. In an embodiment, one could dispense a portion of the solution onto ones hands such that they can be cleaned, or the solution could be dispensed onto a wipe such that the wipe can then be used to clean a desired surface. Wipes may be arranged within a dispenser such that they can be drawn through a re-sealable opening of the container or dispenser or such that by withdrawing one wipe, further wipes are drawn towards or through the opening. This may be achieved by producing unitary wipes with regions of weakness (eg. perforations) that allow smaller wipes to be removed therefrom, or by the folding arrangement of wipes with one another such as is the case with conventional tissue packaging. Arrangements such as these are routinely adopted with refresher towelettes, hand/face cleaning wipes (eg. Wet Ones™) and baby wipes, for example.

In a preferred embodiment the solution is physiologically compatible with skin. This enables one to use the solution without the need to use protective clothing. In addition, the solution could be used to clean ones hands to remove dirt, grime and the like. Preferably, the solution is anti-microbial, enabling the solution to prevent and/or slow the growth and/or kill bacteria and the like. Dispensing canisters, as described above, could be installed in places, where users are required to clean their hands to remove dirt and the like, and/or clean their hands to remove bacteria and the like. Such places include motor workshops, vehicle detailing centres, factories, bathrooms, kitchens, scientific laboratories, doctors' surgeries, hospitals and the like.

The absorbent material does not necessarily need to be lint-free when used on surfaces such as non-optical surfaces. The absorbent material preferably does not substantially break down when in use. As long as the absorbent material containing the cleaning solution is capable of cleaning the desired surface, any material may be used.

It has now been found after extensive testing of one embodiment of the invention that a “streak free” surface results after application of a solution comprising between about 40% and about 60% B.P. grade eucalyptus oil with the remainder of the solution comprising A.R. grade ethanol. The refractive index of this solution has been found to be 1.48, with the contact angle between a clean standard glass surface and water to be 34 degrees and after application of the solution to be 22 degrees. An excess of solvent may diminish the effect of the electrically neutralising barrier while an excess of oil may produce undesirable streaks/smears on the surface after it has been cleaned.

Further uses for the present invention include, for example, cleaning of computer screens, T.V.s, windscreens, windows, lenses, optical glasses, sunglasses, dentist and doctor's instruments, mirrors, shower screens, visors, safety shields, including both head and face protective masks including helmets, and goggles ranging from general eye protection to swimming goggles. As mentioned, the invention can be used to clean, for example, windscreens, but it is not limited to optical components. It can as effectively be used to clean other components of a motor vehicle such as wheel trim and bumper bars, household fixtures, bathroom fittings, bench tops etc. . . . The invention can also be used for mirrors located in high humidity environments, such as bathrooms. It can also be used to clean bathroom fixtures. The wipe, once used in one of the above applications can be reused to clean ones hands. If not in a form able to clean ones hands, for example, too dirty, another wipe, or some additional solution, could be used to clean ones hands.

The present invention also extends to a method of preparing a presaturated wipe for applying a solution to a surface comprising the steps of impregnating a substantially lint-free absorbent material with an appropriate amount of cleaning solution which comprises cineole in an amount of between about 20% and about 60% by weight of the solution and up to about 80% by weight of the solution of a suitable solvent.

Additionally, the present invention also extends to a method of cleaning an optical lens to remove dust, dirt, grime or the like wherein the a substantially lint-free absorbent material impregnated with an appropriate amount of cleaning solution which comprises cineole in an amount of between about 20% and about 60% by weight of the solution and up to about 80% by weight of the solution of a suitable solvent is used.

Finally it will be appreciated that the present invention has been described by way of example only and that modifications and additions may be made thereto without departing from the scope of the invention as defined in the appended claims.

The reference to any prior art in this specification is not, and should not, be taken as an acknowledgment or any form of suggestion that the prior art forms part of the common general knowledge in Australia.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

1. A cleaning solution comprising:
cineole in an amount of between about 20% and about 60% by weight of the solution; and
up to about 80% by weight of the solution of a suitable solvent.

2. A cleaning solution according to claim 1 wherein the said solvent is selected from one or more of C₁ to C₁₀ alcohols.

3. A cleaning solution according to claim 1 wherein the said solvent is selected from one or more of methanol, ethanol, isopropanol and methylated spirits.

4. A cleaning solution according to claim 1 wherein the said solvent is ethanol of analytical grade (A.R).

5. A cleaning solution according to claim 1 wherein the said solution comprises an essential oil fraction comprising cineole.

6. A cleaning solution according to claim 5 wherein the said solution comprises one or more essential oils selected from the group eucalyptus, tea tree, bayleaf, spearmint and rosemary, or fractions thereof.

7. A cleaning solution according to claim 6 wherein the amount by weight of cineole in the eucalyptus oil is at least 60%.

8. A cleaning solution according to claim 6 wherein eucalyptus oil is of B.P. (British Pharmacopoeia) grade.

9. A cleaning solution according to claim 6 to wherein the amount by weight of cineole in the eucalyptus oil is between about 75% and about 85%.

10. A cleaning solution according to claim 1 comprising:
amount by weight of eucalyptus oil between about 40% and about 60%; and wherein ethanol constitutes the remainder of the solution.

11. A cleaning solution according to claim 10 wherein the amount by weight of the eucalyptus oil is 50% and the amount by weight of the ethanol is 50%.

12. A cleaning solution according to claim 1 wherein the said solution is adapted to be sprayed onto a surface.

13. A cleaning solution according to claim 1 wherein the said solution following application to a surface leaves a residue substantially invisible to the naked eye.

14. A cleaning solution according to claim 13 wherein the said residue has a refractive index substantially similar to glass.

15. A cleaning solution according to claim 13 wherein the said residue has a refractive index between about 1.40 and about 1.55.

16. A cleaning solution according to claim 13 wherein the said residue constitutes a substantially electrically neutralising layer.

17. A cleaning solution according to claim 13 wherein the said residue gives rise to the water having an increased ability to spread uniformly on a surface and hence inhibit the formation of droplets and the subsequent perception of mist

18. A cleaning solution according to claim 13 wherein the said residue gives rise to a contact angle of water between 0 and 30 degrees.

19. A cleaning solution according to claim 1 wherein the said solution has anti-microbial activity.

20. A cleaning solution according to claim 1 wherein the said solution acts as an insect repellant.

21. A cleaning solution according to claim 1 wherein the said solution is physiologically compatible with skin.

22. A cleaning solution according to claim 1, substantially as hereinbefore described.

23. A presaturated wipe for applying a cleaning solution to a surface comprising a substantially lint free absorbent material impregnated with a cleaning solution comprising:
cineole in an amount of between about 20% and about 60% by weight of the solution; and
up to about 80% by weight of the solution of a suitable solvent.

24. A presaturated wipe according to claim 23 wherein the said solvent is selected from one or more of C₁ to C₁₀ alcohols.

25. A presaturated wipe according to claim 23 wherein the said solvent is selected from one or more of methanol, ethanol, isopropanol and methylated spirits.

26. A presaturated wipe according to claim 23 wherein the said solvent is ethanol of analytical grade (A.R).

27. A presaturated wipe according to claim 23 wherein the said solution comprises essential oil fraction comprising cineole.

28. A presaturated wipe according to claim 27 wherein the said solution comprises one or more essential oils selected from the group eucalyptus, tea tree, bayleaf, spearmint and rosemary, or fractions thereof.

29. A presaturated wipe according to claim 28 wherein the amount by weight of cineole in the eucalyptus oil is at least 60%.

30. A presaturated wipe according to claim 28 wherein eucalyptus oil is of B.P. (British Pharmacopoeia) grade.

31. A presaturated wipe according to claim 28 wherein the amount by weight of cineole in the eucalyptus oil is between about 75% and about 85%.

32. A presaturated wipe for applying a cleaning solution to a surface according to claim 23 comprising a substantially lint free absorbent material impregnated with a cleaning solution comprising:
amount by weight of eucalyptus oil between about 40% and about 60%; and
wherein ethanol constitutes the remainder of the solution.

33. A presaturated wipe according to claim 32 wherein the amount by weight of the eucalyptus oil is 50% and the amount by weight of the ethanol is 50%.

34. A presaturated wipe according to claim 23 wherein the said solution following application to a surface leaves a residue substantially invisible to the naked eye.

35. A presaturated wipe according to claim 34 wherein the said residue has a refractive index substantially similar to glass.

36. A presaturated wipe according to claim 34 wherein the said residue has a refractive index between about 1.40 and about 1.55.

37. A presaturated wipe according to claim 34 wherein the said residue constitutes a substantially electrically neutralising layer.

38. A presaturated wipe according to claim 34 wherein the said residue gives rise to the water having an increased ability to spread uniformly on a surface and hence inhibit the formation of droplets and the subsequent perception of mist.

39. A presaturated wipe according to claim 34 wherein the said residue gives rise to a contact angle of water between 0 and 30 degrees.

40. A presaturated wipe according to claim 23 wherein the said solution has anti-microbial activity.

41. A presaturated wipe according to claim 23 wherein the said solution acts as an insect repellant.

42. A presaturated wipe according to claim 23 wherein the said solution evaporates on exposure to air, resulting in a substantially dry wipe after use.

43. A presaturated wipe according to claim 23 wherein the wipe is enclosed in a sealed package.

44. A presaturated wipe according to claim 23 wherein the said solution is physiologically compatible with skin.

45. A presaturated wipe according to claim 23 substantially as hereinbefore described.

46. An optical cleaning product comprising a sealed package enclosing one or more presaturated wipes according to claim 23.

47. A method of preparing a presaturated wipe for applying a solution to a surface comprising the steps of:
impregnating a substantially lint-free absorbent material with an appropriate amount of cleaning solution comprising:
cineole in an amount of between about 20% and about 60% by weight of the solution; and
up to about 80% by weight of the solution of a suitable solvent.

48. A method according to claim 47 wherein the said solvent is selected from one or more of C₁ to C₁₀ alcohols.

49. A method according to claim 47 wherein the said solvent is selected from one or more of methanol, ethanol, isopropanol and methylated spirits.

50. A method according to claim 47 wherein the said solvent is ethanol of analytical grade (A.R).

51. A method according to claim 47 wherein the said solution comprises essential oil fraction comprising cineole.

52. A method according to claim 51 wherein the said solution comprises one or more essential oils selected from the group eucalyptus, tea tree, bayleaf, spearmint and rosemary, or fractions thereof.

53. A method according to claim 52 wherein the amount by weight of cineole in the eucalyptus oil is at least 60%.

54. A method according to claim 52 wherein eucalyptus oil is of B.P. (British Pharmacopoeia) grade.

55. A method according to claim 52 wherein the amount by weight of cineole in the eucalyptus oil is between about 75% and about 85%.

56. A method of preparing a presaturated wipe for applying a solution to a surface according to claim 47 comprising the steps of:
impregnating a substantially lint-free absorbent material with an appropriate amount of cleaning solution comprising:
amount by weight of eucalyptus oil between about 40% and about 60%; and
wherein ethanol constitutes the remainder of the solution.

57. A method according to claim 56 wherein the amount by weight of the eucalyptus oil is 50% and the amount by weight of the ethanol is 50%.

58. A method according to claim 47 wherein the said solution solubilises dirt, dust, grime or the like.

59. A method according to claim 47 wherein the said solution following application to a surface leaves a residue substantially invisible to the naked eye.

60. A method according to claim 59 wherein the said residue has a refractive index, substantially similar to glass.

61. A method according to claim 59 wherein the said residue has a refractive index between about 1.45 and about 1.55.

62. A method according to claim 59 wherein the said residue results in an electrically neutralising barrier between glass and air.

63. A method according to claim 59 wherein the said residue gives rise to the water having an increased ability to spread uniformly on a surface and hence inhibit the formation of droplets and the subsequent perception of mist.

64. A method according to claim 59 wherein the said residue gives rise to a contact angle of water between 0 and 30 degrees.

65. A method according to claim 47 to wherein the said solution has anti-microbial activity.

66. A method according to claim 47 to claim 47 wherein the said solution acts as an insect repellant.

67. A method according to claim 59 wherein the said solution evaporates on exposure to air, resulting in a substantially dry material after use.

68. A method according to claim 67 wherein the substantially dry material can be used to buff the said surface.

69. A method according to claim 47 to wherein the said solution is compatible with the surface.

70. A method according to claim 69 wherein the said surface is selected from glass, perspex, plastic or the like.

71. A method according to claim 47 wherein the presaturated wipe is enclosed in a sealed package.

72. A method of producing a cleaning product which comprises packaging a presaturated wipe according to claim 23 in a substantially air impervious package.

73. A method of producing an optical cleaning product comprising a sealed package enclosing one or more presaturated wipes according to claim 1.

74. A method of cleaning an optical lens wherein the substantially lint-free absorbent material impregnated with an appropriate amount of cleaning solution comprising:
cineole in an amount of between about 20% and about 60% by weight of the solution; and
up to about 80% by weight of the solution of a suitable solvent is used.

75. A method of cleaning a surface of an optical lens which comprises wiping a surface with a presaturated wipe according to claim 1 to remove dust, dirt, grime or the like.

76. A method of cleaning hands which comprises wiping the hands with a presaturated wipe according to claim 1 to remove dust, dirt, grime or the like.

77. A method of cleaning hands which comprises wiping the hands with a presaturated wipe according to claim 1 to kill, slow growth and/or cellular division and/or repel micro-organisms.

78. A method of cleaning a surface which comprises wiping a surface with a presaturated wipe according to claim 1 to remove dust, dirt, grime or the like and then using the presaturated wipe to clean the user's hands to remove dust, dirt, grime or the like and/or to kill, slow growth and/or cellular division and/or repel micro-organisms.

79. A method of cleaning a surface which comprises wiping a surface with a presaturated wipe according to claim 1 to remove dust, dirt, grime or the like.
